(19) United States
(12) Patent Application Publication
(10) Pub. No.: US 2025/0375745 A1
(43) Pub. Date: Dec. 11, 2025

(54) Continuous Paste Mixer and Method of Use

(71) Applicant: TBS Engineering Ltd., Brockworth (GB)

(72) Inventors: Shep GERRISH, Pawling, NY (US); Paul ALLISON, Gloucester (GB); Steven SHARPE, Gloucestershire (GB)

(73) Assignee: TBS Engineering Ltd., Brockworth (GB)

(21) Appl. No.: 19/232,780

(22) Filed: Jun. 9, 2025

Related U.S. Application Data
(60) Provisional application No. 63/657,774, filed on Jun. 7, 2024.
(60) Provisional application No. 63/657,776, filed on Jun. 7, 2024.
(60) Provisional application No. 63/657,777, filed on Jun. 7, 2024.
(60) Provisional application No. 63/657,780, filed on Jun. 7, 2024.
(60) Provisional application No. 63/657,781, filed on Jun. 7, 2024.
(60) Provisional application No. 63/657,784, filed on Jun. 7, 2024.
(60) Provisional application No. 63/657,785, filed on Jun. 7, 2024.

(51) Int. Cl. B01F 27/706; B01F 23/53; B01F 23/57; B01F 27/702; B01F 35/00; B01F 35/10; B01F 35/22; B01F 35/221; B01F 35/222; B01F 35/32

(52) U.S. Cl. CPC B01F 27/706; B01F 23/53; B01F 23/57; B01F 27/702; B01F 35/145; B01F 35/165; B01F 35/2202; B01F 35/2206; B01F 35/2211; B01F 35/222; B01F 35/3204

(57) ABSTRACT

A continuous paste mixer comprising a mixing apparatus secured to a frame is described herein. The mixing apparatus includes one or more mixer assemblies configured to extend and stack with respect to the frame, the one or more mixer assemblies to mix various ingredients (thixotropic and/or non-Newtonian) continuously and uniformly without risking uncontrolled exothermic reactions. The continuous paste mixer comprises a support member operatively connected to the mixing apparatus, and a controller configured to automatically control movement and operation of the high-shear mixer during mixing according to one or more mixing profiles.

### RELATED APPLICATIONS

This application claims priority to U.S. Provisional Patent Application No. 63/657,774 titled “Multi-Parameter Control System for Continuous Paste Mixer Enhancing Active Material Energy Density in Battery Production” (“the '774 application”), U.S. Provisional Patent Application No. 63/657,776 titled “Continuous Paste Mixer with Anti-Corrosive Components for Improved System Resistivity to Corrosion in Lead Acid Battery Paste Production” (“the '776 application”), U.S. Provisional Patent Application No. 63/657,777 titled “Continuous Paste Mixer with Density Control for Non-Newtonian Thixotropic Anode and Cathode Fluids in Battery Production” (“the '777 application”), U.S. Provisional Patent Application No. 63/657,780 titled “Continuous Paste Mixer with Lead Particulate Reduction Encapsulation System” (“the '780 application”), U.S. Provisional Patent Application No. 63/657,781 titled “Multi-Parameter Control System for Continuous Paste Mixer Enhancing Active Material Coating, Pasting, and Adhesion in Battery Production” (“the '781 application”), U.S. Provisional Patent Application No. 63/657,784 titled “Continuous Paste Mixer for Controlling Viscosity of Non-Newtonian Thixotropic Lead Acid Anode and Cathode Fluids through Exothermic Reaction Temperature Management via Multi-Stage Continuous Mixing Reactors” (“the '784 application”), and U.S. Provisional Patent Application No. 63/657,785 titled “Continuous Paste Mixer with Temperature Control for Non-Newtonian Thixotropic Anode and Cathode Fluids in Battery Production” (“the '785 application”), each of which was filed on Jun. 7, 2024. The content of each of the '774, '776, '777, '780, '781, '784, and '785 applications is hereby incorporated by reference herein in its entirety.

### FIELD OF THE INVENTION

The present invention relates to the manufacturing process of lead-acid batteries and, more particularly, to the continuous mixing of ingredients to produce lead-acid paste.

### BACKGROUND OF THE INVENTION

Tub paddle mixers cooled with water or by creating vacuum inside are frequently used in battery industry where preparing lead acid paste. Tub paddle mixers are used when there is a need to mix thick, sensitive materials without generating excessive heat in various industries like food processing, pharmaceutical creams, plastic compounds, paints and coatings, etc. However, tub paddle mixers are not specifically designed for non-Newtonian thixotropic materials like lead-acid battery paste.

Indeed, conventional tub paddle mixers have several disadvantages, including insufficient shear for proper dispersion, longer mixing times, poor handling of high viscosity, inconsistent mixing of non-Newtonian fluids, challenges in controlling thixotropic recovery, and limited flexibility for batch size and scale. For example, conventional tub mixers could have high shear, but the shear stress is limited by a diameter of the paddle and/or a gap between the paddle and a wall of the mixer where the paddle is located within. The low shear force (or intensity) may not adequately break down agglomerates or ensure uniform dispersion of solid particles within the paste. And due to their low shear force, conventional tub paddle mixers require longer mixing time to achieve a homogeneous mixture. As a result, the paste may not have correct viscosity when applying to battery plates, resulting in operational inefficiencies. Conventional paddle mixers also often struggle to effectively move and mix highly viscous materials, particularly in corners or near walls of the tub, leading to incomplete mixing. Lead-acid paste, being non-Newtonian, also changes its viscosity based on amount of shear applied. In conventional paddle mixers, shear forces are not uniformly distributed throughout a mixing vessel. Thixotropic materials such as lead-acid paste also recover their viscosity over time after shear forces are removed. As a result, if paste is too fluidic when applying to battery plates or if paste thickens too quickly after mixing, paste could sag or adhere poorly on the battery plates. Finally, large batches may suffer from uneven mixing, while smaller batches may not be economically feasible due to limitations of paddle mixer design.

A continuous paste mixer that may overcome the aforementioned disadvantages without risking uncontrolled exothermic reactions would be a significant improvement over conventional paste mixing processes.

### SUMMARY OF THE INVENTION

Aspects of this disclosure relate to various embodiments of a continuous paste mixer that comprises a mixing apparatus secured to a frame. The mixing apparatus includes one or more mixer assemblies configured to extend and stack with respect to the frame, the one or more mixer assemblies to mix various ingredients (thixotropic and/or non-Newtonian) continuously and uniformly without risking uncontrolled exothermic reactions. The continuous paste mixer comprises a support member operatively connected to the mixing apparatus, and a controller configured to automatically control movement and operation of the high-shear mixer during mixing according to one or more mixing profiles. In some embodiments, the one or more mixer assemblies includes an elongated paddle shaft assembly with one or more paddles of coaxially and slidably received within a pair of parallelly rotating shafts and configured to mix any appropriate type of paste ingredients.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIGS. 1A-1B depict perspective views of an example continuous paste mixer, according to one or more aspects described herein;

FIGS. 2A-2B depict perspective views of example mixer assemblies forming a mixing apparatus of continuous paste mixer, according to one or more aspects described herein;

FIGS. 3A-3B depict perspective views of example paddle shaft assemblies within mixer assemblies of continuous paste mixer, according to one or more aspects described herein;

FIG. 4 depicts a schematic view of an example continuous paste mixer, according to one or more aspects described herein;

FIGS. 5A-5B depict perspective views of components configured to facilitate control of a continuous paste mixer using one or more mixing profiles, according to one or more aspects described herein;

FIGS. 6A-6B depict perspective views of an example temperature management sub-system of a continuous paste mixer, according to one or more aspects described herein; and

FIG. 7 depicts a flow diagram of an example method for mixing two or more materials utilizing a continuous paste mixer, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention described herein relates to a continuous paste mixer comprising a mixing apparatus secured to a frame. The mixing apparatus includes one or more mixer assemblies configured to extend and stack with respect to the frame, the one or more mixer assemblies to mix various ingredients (thixotropic and/or non-Newtonian) continuously and uniformly without risking uncontrolled exothermic reactions. The continuous paste mixer comprises a support member operatively connected to the mixing apparatus, and a controller configured to automatically control movement and operation of the high-shear mixer during mixing according to one or more mixing profiles. In some embodiments, the one or more mixer assemblies includes an elongated paddle shaft assembly with one or more paddles of coaxially and slidably received within a pair of parallelly rotating shafts and configured to mix any appropriate type of paste ingredients.

Paste used in pasting plates for lead-acid batteries is a non-Newtonian fluid. This means that its viscosity can change depending on shear rate or stress applied to the paste. When mixed and manipulated, paste behaves differently compared to Newtonian fluids (e.g., water), which have a constant viscosity regardless of the applied stress. In contrast, thixotropic fluid is a type of non-Newtonian fluid that decreases in viscosity over time when subjected to a constant shear stress or agitation, and gradually returns to a more solid-like state (with higher viscosity) when left undisturbed. Lead-acid battery paste is considered a thixotropic fluid because (i) during application (when paste is being mixed, spread, or applied to the battery plates), shear stress may cause it to become more fluid (with lower viscosity), making it easier to work with, and (ii) when at rest (once the shear force is removed (e.g., after application)), the paste thickens and solidifies over time, which helps it maintain its shape on the plates before it is dried and cured.

Mixing a thixotropic paste for lead-acid batteries can be challenging due to several factors. For example, a paste's initial high viscosity can make it difficult to incorporate all components evenly, requiring more force or energy to mix. From a particle size point of view, mixing various ingredients (having varying particle sizes) may lead to uneven dispersion, if not mixed thoroughly. From a thixotropic nature point of view, while paste becomes more fluid under shear stress, paste may quickly revert to a thicker state once mixing stops. This may make it hard to achieve uniform consistency without continuous mixing. With respect to maintaining consistency, due to changing viscosity and time-dependent behavior of paste, it may be difficult to replicate the same consistency, especially if paste stays a certain time before is being pasted. Finally, regarding control of mixing time, as thixotropic fluids change over time, duration of mixing requires much more careful control.

The invention described herein addresses the above problems by mixing paste without risking uncontrolled exothermic reactions during paste preparation. The systems and methods described herein utilize a multi-stage, high-shear mixing apparatus that may handle a paste with thixotropic and non-Newtonian properties, such as lead-acid battery paste. The multi-stage, high-shear mixing apparatus may include a set of mixing assemblies (which may each include an elongated paddle shaft assembly) and one or more monitoring sub-assemblies (e.g., which may include temperature, humidity, and density monitoring sensors) that allow for high high-shear mixing with the capability to monitor and track progress in real-time.

For example, high-shear mixing reactor may provide followings: 1) Effective Handling of Shear-Thinning Behavior: High-shear zones reduce the viscosity, making the paste easier to mix and ensuring uniform distribution of the solid particles throughout the liquid phase. This reduction in viscosity during mixing prevents the paste from becoming too thick or difficult to handle, ensuring that the paste can be thoroughly mixed in a shorter amount of time. 2) Efficient Particle Dispersion: The high shear forces generated in these mixers break up clusters of solid particles, ensuring a uniform dispersion, which is critical for the performance of the battery plates. 3) Shorter Mixing Time: High-shear mixers can achieve homogenous mixing in a relatively shorter time compared to low-shear or traditional mixers. 4) Control Over Paste Consistency: High-shear mixers offer precise control over the shear forces applied during mixing. This flexibility helps ensure that the paste has the right balance of viscosity for both mixing and application. 5) Better Heat Control: High-shear mixers, due to their shorter mixing times and the ability to handle heat more efficiently, reduce the likelihood of excessive heat generation. 6) Scalability for Large-Scale Production: Lead-acid battery manufacturing often requires large-scale production of paste, and high-shear mixers are capable of handling this without sacrificing the uniformity or quality of the paste. 7) Adaptability for Batch or Continuous Mixing: High-shear mixers can be used in both batch and continuous mixing setups, offering flexibility depending on the production requirements. For mixing lead-acid paste at high rates a continuous mixer is more suited. High-shear continuous mixers can handle a steady flow of materials, providing efficiency in larger production environments while maintaining the necessary mixing intensity to process the paste correctly.

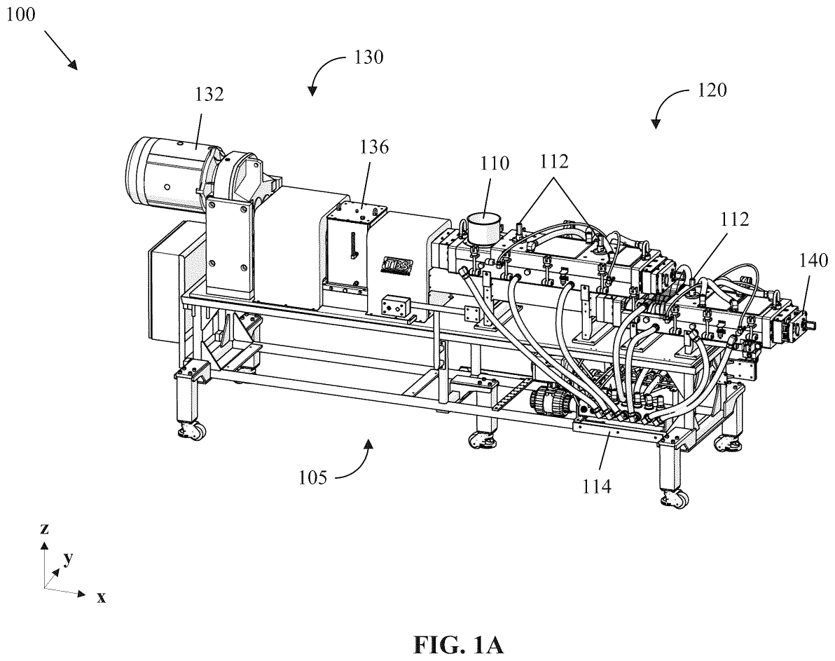

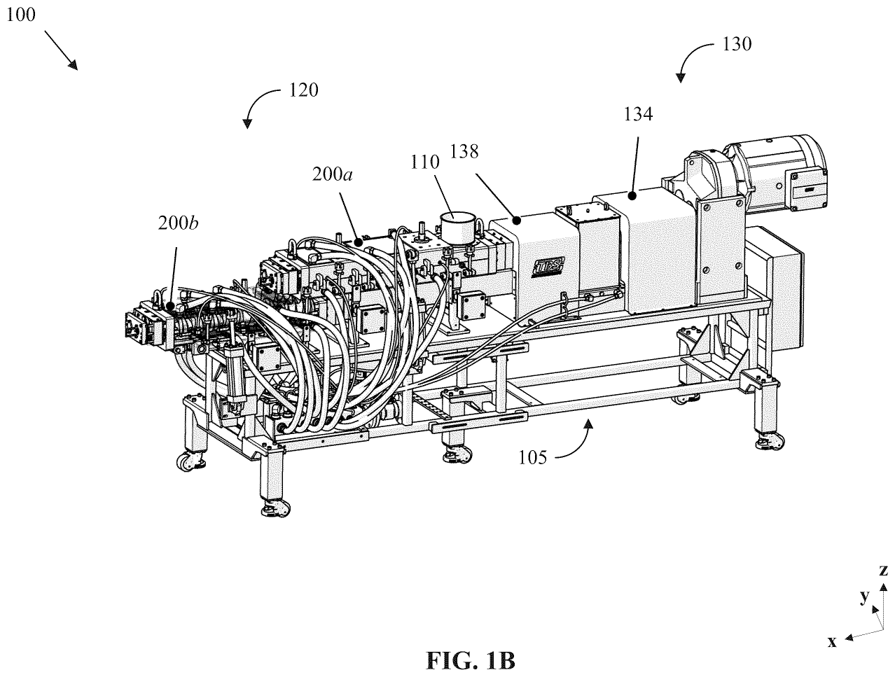

FIGS. 1A and 1B depict perspective views of continuous paste mixer 100, according to one or more aspects described herein. For example, FIG. 1A depicts a front perspective view of continuous paste mixer 100, and FIG. 1B depicts a rear perspective view of continuous paste mixer 100. In various embodiments, continuous paste mixer 100 may include a plurality of inlets or supply ports, a mixing apparatus 120, a drive assembly 130, an output gate 140, and/or one or more other components installed on or attached to a frame 105. For example, as depicted in at least FIGS. 1A-B, the plurality of inlets or supply ports may include a dry ingredient inlet 110, one or more acid supply ports 112 (e.g., sulphuric acid supply ports), a water inlet manifold 114 supplying (cooling) water via one or more water supply hoses/ports, and/or one or more other inlets or supply ports.

In various embodiments, mixing apparatus 120 may comprise one or more mixer assemblies 200 configured to mix various ingredients (e.g., lead oxide, acid, water, and additives) continuously and uniformly without risking uncontrolled exothermic reactions. For example, in various embodiments, mixing apparatus 120 may include at least a first (or upper) mixer assembly 200a and a second (or lower) mixer assembly 200b. Additional mixer assemblies 200 are also expressly contemplated herein.

In various embodiments, the various components of continuous paste mixer 100, including mixing apparatus 120, may be securely attached, either directly or indirectly, to a frame 105. For example, mixing apparatus 120 may be configured to be mounted on top of frame 105. When mixing apparatus 120 is installed on or attached to a frame 105, the one or more mixer assemblies 200 of mixing apparatus 120 may be configured to extend and stack with respect to frame 105. For example, the one or more mixer assemblies 200 of mixing apparatus 120 may extend horizontally (i.e., along x-axis) and stack (be stackable) vertically (i.e., along z-axis) with respect to frame 105. In various embodiments, such an arrangement may form a series of multi-stage mixer assemblies 200, interconnected in a sequential arrangement, specifically designed for production of lead acid battery paste. In various embodiments, the one or more mixer assemblies 200 of mixing apparatus 120 may be automatically controlled to mix various ingredients (e.g., lead oxide, acid, water, additives, and/or other ingredients) continuously and uniformly without risking uncontrolled exothermic reactions during paste preparation. In various embodiments, the one or more mixer assemblies 200 of mixing apparatus 120 may each include an elongated paddle shaft assembly 210 for mixing various ingredients (e.g., dry ingredients received via dry ingredient inlet 110, and acid and water received, for example, via one or more acid supply ports 112 or a water inlet manifold 114) continuously and uniformly without risking uncontrolled exothermic reactions.

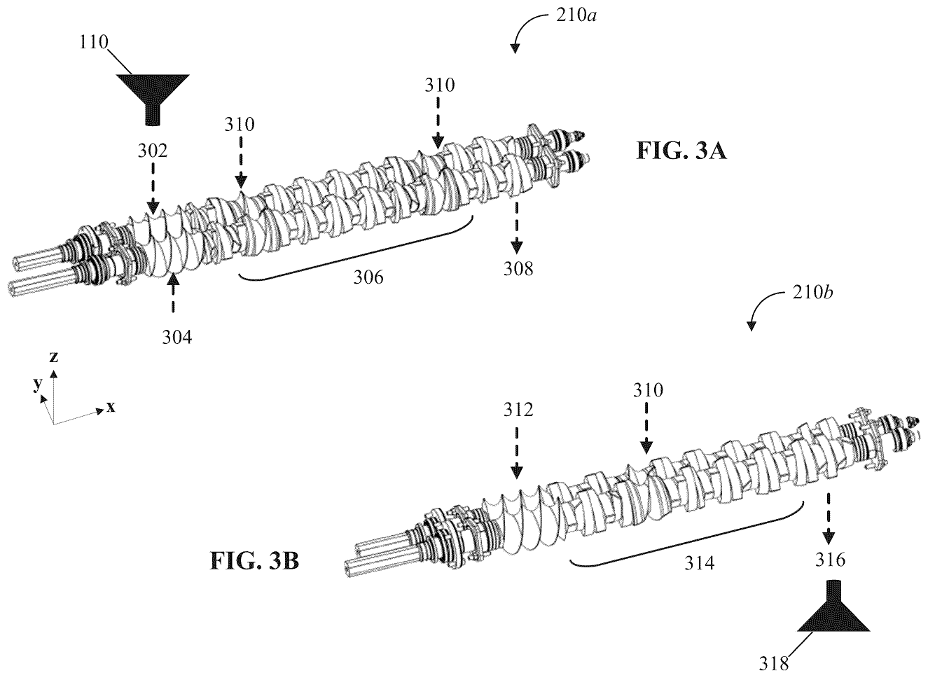

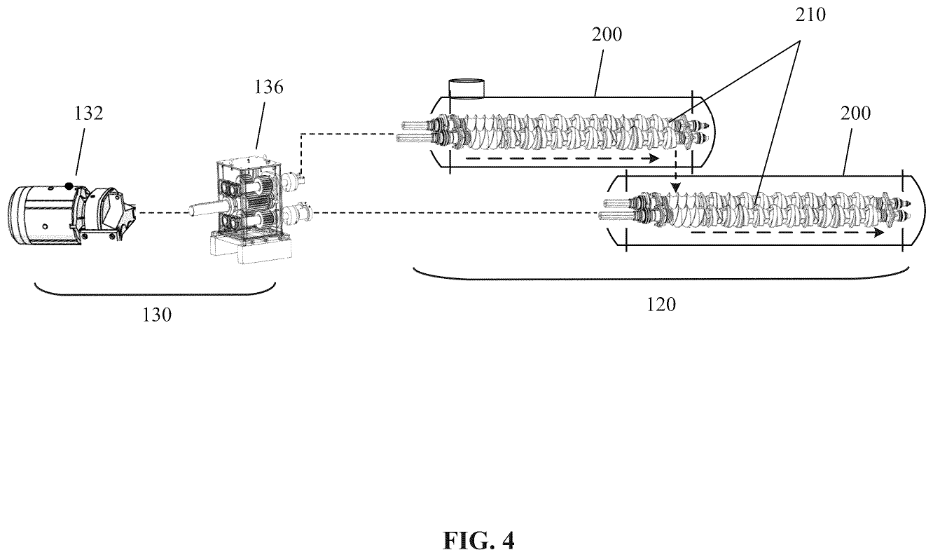

In various embodiments, drive assembly 130 may be configured to provide mechanical (i.e., rotatable) energy or power to mixing apparatus 120 to rotate a pair of shafts (i.e., forming a paddle shaft assembly 210, as depicted in FIGS. 3A-B) of mixing apparatus 120 continuously and uniformly without risking uncontrolled exothermic reactions. In various embodiments, drive assembly 130 may include an electric motor 132, a coupling guard 134, a gearbox 136, a driveshaft guard 138, one or more encoders (e.g., ENC01-02 as depicted and described with respect to FIG. 4A) and/or one or more other components.

In various embodiments, continuous paste mixer 100 may be connected to (or configured to be connected to) or interface with one or more other systems, devices, or components. For example, in some embodiments, continuous paste mixer 100 may be connected to (or configured to be connected to) or interface with a dry ingredients feeding system, a water and acid dosing system, and/or one or more other similar systems, devices, or components. For example, continuous paste mixer 100 may be configured to continuously and uniformly mix various ingredients, such as dry ingredients from a dry ingredients feeding system and both water and acid from a water and acid dosing system. In an example embodiment, a dry ingredients feeding system and a water and acid dosing system may be used with continuous paste mixer 100 to ensure uniform dispersion (e.g., through the filtration of dry ingredients) and precise dosing of various ingredients (e.g., through the controlled measuring and release of water and acid).

In various embodiments, continuous paste mixer 100 may be connected to coater and/or another component or system via output gate 140. In some embodiments, mixing apparatus 200 may be connected to a water and acid dosing system via one or more hydraulic hoses. In some embodiments, various components mounted to frame 105 may be connected to mixing apparatus 120 via hydraulic and/or electrical umbilical cords (which may include hydraulic hoses described herein).

In various embodiments, frame 105 may be may be placed “horizontally” (i.e., on the x-y plane) such that drive assembly 130 and mixing apparatus 120 may be mounted to frame 105 generally perpendicular to a horizontal plane (i.e., on the x-y plane). In various embodiments, a coater (or coating system) may be positioned adjacent or otherwise in close proximity to mixing apparatus 120, for example, via output gate 140. In some embodiments, output gate 140 may comprise a programmable hydraulic output gate. In some embodiments, continuous paste mixer 100 may also include a controller, a pump and heat source, and/or one or more other components.

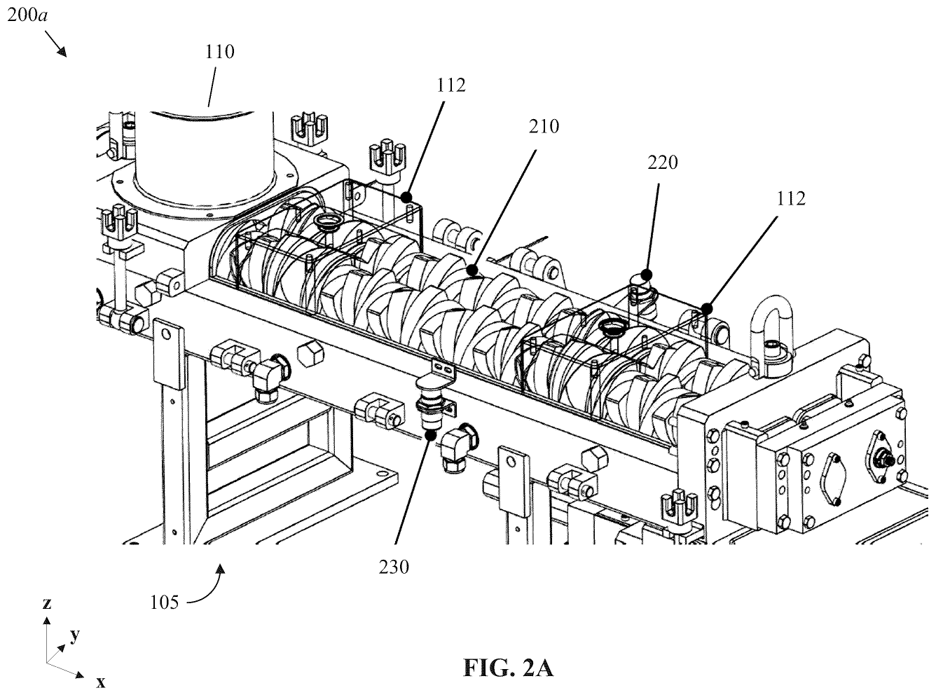

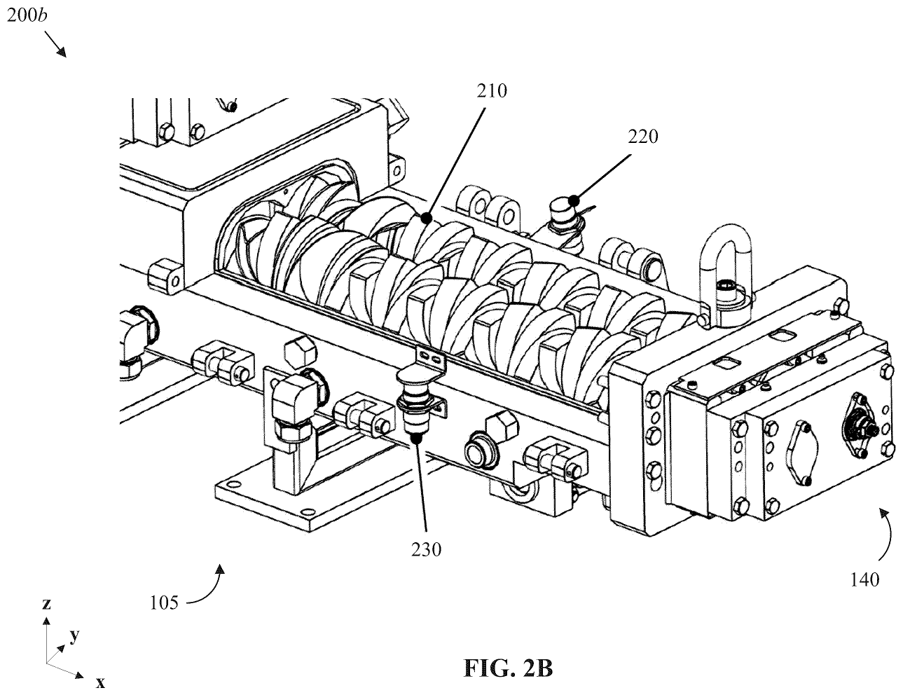

FIGS. 2A-B depict perspective views of example mixer assemblies 200 forming a mixing apparatus 120 of continuous paste mixer 100, according to one or more aspects described herein. As described herein, mixing apparatus 120 may comprise one or more mixer assemblies 200. As also depicted and described herein with respect to FIGS. 1A-B, mixing apparatus 120 may include at least a first (or upper) mixer assembly 200a and a second (or lower) mixer assembly 200b. For example, FIG. 2A depicts a perspective view of a first (or upper) mixer assembly 200a, and FIG. 2B depicts a perspective view of a second (or lower) mixer assembly 200b. To facilitate understanding, first (or upper) mixer assembly 200a and second (or lower) mixer assembly 200b are depicted without a top portion of a housing. In some embodiments, a mixer assembly 200 may also include a barrel open sensor 220, a barrel closed sensor 230, and/or one or more other components.

FIGS. 3A-B depict perspective views of example paddle shaft assemblies 210 within mixer assemblies 200 of continuous paste mixer 100, according to one or more aspects described herein. As described herein, in some embodiments, mixing apparatus 120 may include two or more mixer assemblies 200 configured to mix various ingredients, each mixer assembly 200 including a paddle shaft assembly 210. In various embodiments, the paddle shaft assembly 210 included in each mixer assembly 200 of continuous paste mixer 100 may be the same or may differ. For example, as described herein, mixing apparatus 120 may include at least a first (or upper) mixer assembly 200a and a second (or lower) mixer assembly 200b. In such an embodiment, FIG. 3A may depict a perspective view of a paddle shaft assembly 210a included within first (or upper) mixer assembly 200a, and FIG. 3B may depict a perspective view of a paddle shaft assembly 210b included within second (or lower) mixer assembly 200b. In various embodiments, each paddle shaft assembly 210 may include a pair of parallel rotating shafts with mixing paddles separated by alternating stationary flow control discs to direct paste constituents radially across a length of mixer assembly 200 in a predetermined controlled rolling action as paste moves through the mixer assembly 200.

In various embodiments, each mixer assembly 200 of mixing apparatus 120 may be configured to extend and stack with respect to frame 105. For example, referring back to FIGS. 2A-B, a pair of shafts (i.e., mixer assemblies 200a, 200b) may be mounted to rotate longitudinally along a plane between dry ingredient inlet 110 and output gate 140. As depicted in FIG. 3A, in a first paddle shaft assembly 210a, a portion on each shaft at inlet end may be a forward screw to convey feed material at feed points (e.g., a dry ingredient feed point 302 and process water feed point 304) into a middle portion 306 of first paddle shaft assembly 210a towards a first discharge point 308. In some embodiments, sulfuric acid may be fed at feed points 310 to mix with the feed material and move them towards discharge point 308 of first paddle shaft assembly 210a. In some embodiments, various types of paddles may include a mixing ratio and/or a conveying ratio (or mixing/conveying profile).

Similarly, as depicted in FIG. 3B, in a second paddle shaft assembly 210b, which may be stacked or located vertically (i.e., along z-axis) with respect to first paddle shaft assembly 210a, a portion on each shaft at inlet end may be a forward screw to convey material from a feed point 312 (e.g., aligning with discharge point 308 of the first paddle shaft assembly 210a) into a middle portion 314 second paddle shaft assembly 210b towards a discharge point 316 of second paddle shaft assembly 210b. In some embodiments, sulfuric acid may be injected at feed point 310 (and/or at other points along either paddle shaft assembly 210) to mix with the feed material and move them towards their respective discharge points.

As described herein, each mixer assembly 200 may include a paddle shaft assembly 210 comprising one or more shafts coaxially and slidably received and configured to mix any appropriate type of paste ingredients. In various embodiments, a paddle shaft assembly 210 may include various types of mixing paddles. For example, the mixing paddles forming any given paddle shaft assembly may be selected from among helix paddles (e.g., configured to be positioned at entrances of the one or more mixer assemblies) used for conveying material quickly, helical paddles configured to convey paste through the mixer assembly 200, flat paddles configured to mix materials, acid paddles (e.g., configured to be positioned under each acid port) including a combination of different type of paddles and configured to mix acid into the paste more quickly, and/or one or more other types of paddles. In various embodiments, various types of paddle may be coaxially and/or slidably received within a pair of parallelly rotating shafts and configured to mix any appropriate type of paste ingredients. In some embodiments, each mixer assembly 200 and/or mixing apparatus 120 may be a non-circular, rectangular, polygonal, triangular, oval, or a combination of any appropriate shape to facilitate the one or more structural units.

In various embodiments, continuous paste mixer 100 may include a controller configured to automatically control or facilitate control of the mixing apparatus 120 positioned adjacent or otherwise in close proximity to frame 105 (e.g., within frame) using hydraulic actuators. For example, the controller may be configured to automatically control movement and operation of the high-shear mixer assemblies 200 during mixing according to one or more mixing profiles, as described further herein. In various embodiments, the controller of continuous paste mixer 100 may include or comprise one or more processors configured to provide information processing capabilities in continuous paste mixer 100. For example, the one or more processors may comprise a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. The processor(s) of the controller may be configured to execute one or more computer readable instructions. In various embodiments, the controller of continuous paste mixer 100 may be included within one or more components of continuous paste mixer 100 described herein (such as, e.g., included within a mixer assembly 200 or otherwise provided as part of mixing apparatus 120), or may be located separately and/or remotely from the one or more other components of continuous paste mixer 100 described herein. As would be appreciated by a person having ordinary skill in the art, the components of continuous paste mixer 100 may be variously combined or contained within one or multiple components or the components may be separated and/or included in other components without departing from the scope of the invention.

FIG. 4 depicts a schematic view of continuous paste mixer 100, according to one or more aspects described herein. As depicted, for example, in FIGS. 1A-B, continuous paste mixer 100 may a mixing apparatus 120 having a series of multi-stage mixer assemblies 200 (each with an elongated paddle shaft assembly 210) and a drive assembly 130 having at least a motor 132 and a gearbox 136. Through the use of these components, a controller of continuous paste mixer 100 may be configured to automatically control or facilitate control of the mixing process.

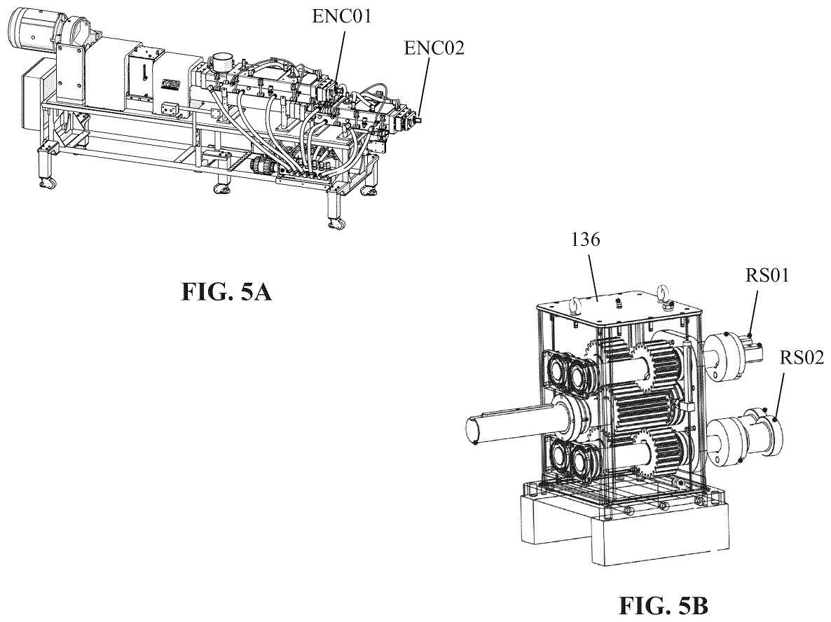

For example, FIGS. 5A-B depict perspective views of components configured to facilitate control of continuous paste mixer 100 using one or more mixing profiles, according to one or more aspects described herein. For example, FIG. 5A depicts a perspective view of an example shaft feedback sub-assembly of mixing apparatus 120, and FIG. 5B depicts a perspective view of an example gear feedback sub-assembly of drive assembly 130. In various embodiments, as depicted in FIGS. 5A-B, synchronized rotation of components of mixing apparatus 120 may be facilitated based on mixing profile control using shaft feedback sub-assembly (e.g., from various encoders ENC01-ENC02), gear feedback sub-assembly (e.g., gear ratio of rotating shafts RS01, RS02), the various types of paddles of the one or more paddle shaft assemblies 210, and/or one or more other components. For example, rotating shafts RS01, RS02 by a gearbox 136 may rotate opposed paddles based on mixing profile to direct paste material radially along a length of a mixer assembly 200 (as depicted in FIGS. 3A-B) and/or to provide thorough mixing with a fast kneading action.

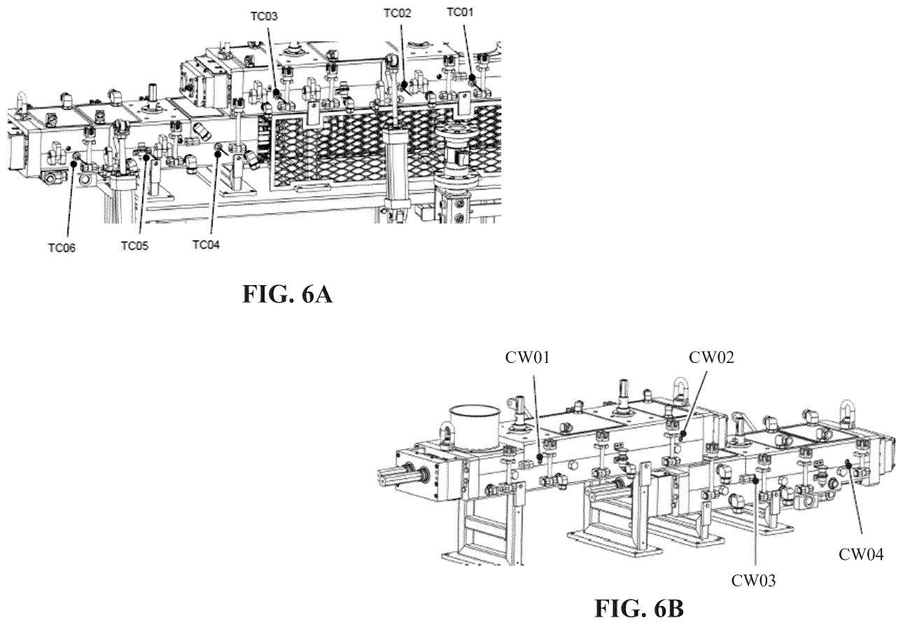

In various embodiments, mixing apparatus 120 may include various feedback sub-assemblies. FIGS. 6A-B depict perspective views of an example temperature management sub-system of continuous paste mixer 100, according to one or more aspects described herein. For example, FIG. 6A depicts an perspective view of an example temperature feedback sub-assembly (e.g., from various thermocouples TC01-TC06), and FIG. 6B depicts an perspective view of an example cooling water sub-assembly (e.g., from cooling water inlet/outlet ports CW01-CW04). In various embodiments, mixing apparatus 120 may include an intercooler technology configured to provide continuous cooling to top and bottom of mixing apparatus 120 with sequential temperature monitoring. In various embodiments, no external air flow and/or environmental may impact on temperature or moisture within mixing apparatus 120. In various embodiments, optimal paste mixing temperature leads to uniform crystals, better acid penetration, increased surface area, better current flow, active material efficiency, improved charge/discharge characteristics and better battery performance. In some embodiments, to obtain the desired temperature of mixing paste from one or more mixer assemblies 200 of mixing apparatus 120 (e.g., from discharge outlet 318 of FIG. 3B), a heater and/or a cooling fan may be used. In an example embodiment, a flow heat exchanger may be used in order to maintain the paste ingredients to a constant temperature. In some embodiments, the cooling fan may be an active cooling unit (e.g., a refrigeration unit) to provide the desired cooling to the mixing paste. Any suitable system and/or method of heating and/or cooling the mixing paste to control the temperature of the mixing paste may be utilized, and all such systems and/or methods are fully intended to be included within the scope of the embodiments described herein.

In various embodiments, a controller of continuous paste mixer 100 may include or comprise an integrated multi-parameter control system configured to optimize viscosity, temperature, and density of non-Newtonian thixotropic anode and/or cathode fluids used in battery production. In various embodiments, continuous paste mixer 100 may control (or manage) exothermic reaction temperature and moisture content through multi-stage continuous mixing reactors, enabling precise control over material properties. By producing material sets with increased active material energy density, continuous paste mixer 100 may be configured to enhance performance and efficiency of batteries for various application.

In various embodiments, and contrary to conventional paste mixers, the mixing assemblies 200 of continuous paste mixer 100 described herein may be controlled independently. For example, the various mixing assemblies 200 of continuous paste mixer 100 may be controlled independently according to one or more mixing profiles to allow for greater control and manipulation of materials throughout process.

In various embodiments, multiple inlets or supply ports of multi-stage paste mixer (i.e., continuous paste mixer 100) may also be independently controlled, for example, to regulate control contents (e.g., dry ingredients, acid, or cooling water) from dry ingredient inlet 110, one or more acid supply ports 112, water inlet manifold 114 supplying (cooling) water, and/or one or more other inlets or supply ports. For example, as depicted in FIG. 6B, cooling water from cooling water inlet/outlet ports CW01-CW04 may be independently controlled based on temperature measured from various thermocouples TC01-TC06, as depicted in FIG. 6A, respectively, to optimize viscosity, temperature, and density of non-Newtonian thixotropic anode and/or cathode fluids used in battery production. As another example, cooling water may be supplied at different time/duration and/or different mixing ratio based on temperature measured from various thermocouples TC01-TC06, independently and respectively, to optimize viscosity, temperature, and density of non-Newtonian thixotropic anode and/or cathode fluids used in battery production. Yet as another example, acid and/or cooling water may be supplied independently, as depicted in FIGS. 3A-B, a first amount/mixing ratio at first middle portion 306 and discharge point 308 while a second amount/mixing ratio at feed point 312 and second middle portion 314 based on one or more mixing profiles.

In various embodiments, the controller of continuous paste mixer 100 may be configured to enable mixing apparatus 120 to be controlled and/or remotely controlled. In some embodiments, the controller may facilitate mixing lead oxide (PbO), with sulfuric acid (H₂SO₄), water (H₂O) and different ingredients depending on types of paste (positive or negative). In other embodiments, water may be added in paste mixing as a pore melding agent during paste preparation.

In various embodiments, the controller may be configured to monitor two or more materials on a target parameter of a multi-parameter control system via one or more monitoring device, adjust valves of feeding pumps or discharging pumps, and regulate mixing parameters for paste ingredients within one or more mixing assemblies 200. For example, in some embodiments, the controller may be configured to control various aspects of mixing apparatus 120 or the operating system of continuous paste mixer 100 based on measured data acquired by one or more monitoring devices. In some embodiments, using measured data acquired by one or more monitoring devices, the controller may be configured to automatically adjust mixing of paste ingredients from one or more mixing assemblies 200 when the amount of two or more materials is below a threshold amount. Any appropriate controlling configuration regarding automatic and/or manual operation is contemplated and is not limited in this regard.

In some embodiments, the controller may be configured to automatically control the position of one or more mixing assemblies 200 (or respective paddle shaft assemblies 210) based on pre-programmed patterns, mixing modes, and/or mixing profiles (which may specify one or more pre-programmed durations and/or patterns of movement for the high-shear mixer for mixing the ingredients in the one or more extendable high-shear mixer assemblies). For example, one or more pre-programmed patterns, mixing modes, and/or mixing profiles may be stored in electronic storage accessible by the operating system of continuous paste mixer 100. In some embodiments, the one or more pre-programmed patterns, mixing modes, and/or mixing profiles to be used may be automatically selected based on the size of ingredients to mix, the shape of ingredients, the material stored in the controller, and/or one or more other factors.

In other embodiments, the one or more pre-programmed patterns or mixing modes may be automatically selected for a given one or more mixer assemblies 200. In various embodiments, mixing profiles may be utilized that specify at least one pre-programmed duration and/or pattern of movement for the high-shear mixer for mixing the ingredients in the one or more mixer assemblies. For example, electronic storage accessible by the operating system of continuous paste mixer 100 may be configured to store one or more mixing profiles that define one or more patterns, durations, one or more mixer assemblies 200 mixing modes, and/or types of paddles to be used for a given profile. In some embodiments, a user may select a given profile for a one or more mixer assemblies 200. In some embodiments, the controller of continuous paste mixer 100 may be configured to automatically select or determine one or more pre-programmed patterns or mixing modes for a given one or more mixer assemblies 200 based on knowledge of a train and/or specific paste. For example, the controller may be configured to automatically select one or more patterns, durations, mixing modes, and/or types of paddles based on the size, shape, type, and/or ingredients of one or more mixer assemblies 200, and/or one or more other factors.

In an example implementation, the mixing operation of one or more mixer assemblies 200 with respect to ingredients may be programmed by the controller according to the pre-programmed pattern or mixing mode selected. For example, the mixing operation may be programmed in a horizontal configuration of the one or more mixer assemblies 200. In some implementations, the pre-programmed pattern or mixing mode selected may indicate the duration of the mixing session, the amount of water and/or acid discharged into one or more mixer assemblies 200, the flow rate of water and/or acid within one or more mixer assemblies 200, the pressure of the water and/or acid emitted within one or more mixer assemblies 200, and/or one or more other adjustable aspects of mixing apparatus 120.

In some embodiments, the controller of continuous paste mixer 100 may be configured to use one or more density monitoring sub-assemblies (e.g., which may include density monitoring sensors) to identify mixing-related characteristics (e.g., density level or type) of ingredients within mixing assemblies 200 and determine one or more mixing profiles (or associated parameters, such as pattern, duration, mixing mode, and/or type of one or more mixing assemblies 200) to perform high-shear mixing within mixing apparatus 120 when mixing ingredients within the one or more mixing assemblies 200. For example, operating system of continuous paste mixer 100 may identify energy density by measuring weight of bulk solids together with volume of a feed hopper.

In various embodiments, one or more monitoring devices included within or used in conjunction with continuous paste mixer 100 may include a self-cleaning device to clean one or more mixing assemblies 200 and/or one or more other components. For example, the controller may be configured to monitor one or more mixing assemblies 200 and/or one or more other components of continuous paste mixer 100. If the controller determines that one or more components require cleaning (e.g., based on a predefined threshold level), the controller may be configured to utilize a self-mixing device to automatically clean the one or more mixing assemblies 200 and/or other components of continuous paste mixer 100.

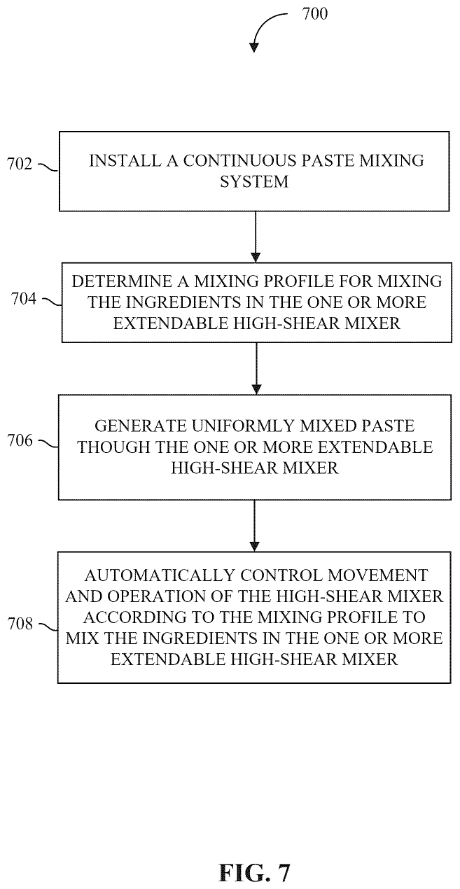

FIG. 7 illustrates an example of a process 700 for mixing two or more materials utilizing a continuous paste mixer, according to one or more aspects described herein. The operations of process 700 presented below are intended to be illustrative and, as such, should not be viewed as limiting. In some implementations, process 700 may be accomplished with one or more additional operations not described, and/or without one or more of the operations discussed. In some implementations, two or more of the operations of process 700 may occur substantially simultaneously. The described operations may be accomplished using some or all of the components of continuous paste mixer 100 described in detail above.

In an operation 702, process 700 may include installing a continuous paste mixer comprising a mixing apparatus secured to a frame, the mixing apparatus including one or more mixer assemblies configured to extend and stack with respect to the frame, the one or more mixer assemblies to mix ingredients (thixotropic and/or non-Newtonian) continuously and uniformly without risking uncontrolled exothermic reactions.

In various embodiments, installing continuous paste mixer may include preparing various types of paddle required for a specific application within one or more mixer assemblies 200. For example, preparing various types of paddles may include preparing mixer assemblies 200 of mixing apparatus 120 with 1) helix paddles configured to be at entrances of the one or more mixer assemblies 200 and are used for conveying material quickly, 2) helical paddles configured to convey paste through the one or more mixer assemblies 200, 3) flat paddles configured to mix materials, and/or 4) acid paddles may be located under each acid port, and include a combination of helix, helical and flat paddles, and may be configured to mix acid into the paste more quickly. In various embodiments, various types of paddle may be coaxially and/or slidably received within a pair of parallelly rotating shafts and configured to mix any appropriate type of paste ingredients.

In an operation 704, process 700 may include determining one or more pre-programmed patterns or mixing modes to use may include determining a mixing profile for mixing the ingredients in the one or more mixer assemblies. In some embodiments, one or more pre-programmed patterns or mixing modes for mixing the ingredients in the one or more mixer assemblies (and/or one or more mixing profiles specifying a pre-programmed duration and/or pattern of movement for the high-shear mixer for mixing the ingredients in the one or more mixer assemblies) may be stored in electronic storage accessible by the operating system of continuous paste mixer 100. In some embodiments, the one or more pre-programmed patterns, mixing modes, and/or mixing profiles to be used may be automatically selected based on the size of one or more mixer assemblies 200 of mixing apparatus 120, the shape of one or more mixer assemblies 200, the material being processed in one or more mixer assemblies 200, and/or other information known or determined about one or more mixer assemblies 200. In other embodiments, the one or more pre-programmed patterns, mixing modes, and/or mixing profiles to be used may be selected via user input. For example, a controller of continuous paste mixer 100 may be configured to receive user input indicating at least one mixing profile used to automatically control movement and operation of the high-shear mixer during mixing. In some embodiments, prior to generating uniformly mixed paste, process 700 may include mapping an interior contour of one or more mixer assemblies 200, such that one or more pre-programmed patterns, mixing modes, and/or mixing profiles may be automatically determined by the controller based on the mapped (or learned) interior of the one or more mixer assemblies 210 of mixing apparatus 120.

In an operation 706, process 700 may include generating uniformly mixed paste though the one or more mixer assemblies. In some embodiments, prior to generating uniformly mixed paste, process 700 may include determining one or more pre-programmed patterns or mixing modes based, for example, on one or more of a size, a shape, and/or a material stored in controller 700.

In an operation 708, process 700 may include automatically controlling movement and operation of the high-shear mixer according to the mixing profile to mix the ingredients in the one or more mixer assemblies. In some embodiments, process 700 may further include monitoring two or more material on a target parameter of a multi-parameter control system to measure an amount of the two or more material. For example, process 700 may include detecting two or more material in mixing apparatus 120 based on measured data acquired by a one or more monitoring devices. In some embodiments, process 700 may include utilize functionality measuring weight and/or volume to identify density of the two or more material to be used in mixing apparatus 120.

In an operation 710, process 700 may further include adjusting one or more pre-programmed patterns or mixing modes based on the measured amount of the two or more material. In other embodiments, after mixing the two or more material, process 700 may further include adjusting mixer assemblies 200 of mixing apparatus 120 to generate another type of battery paste. For example, process 700 may further include adjusting and replacing one or more paddles or otherwise manipulating position of one or more paddles of elongated paddle shaft assembly 210.

In some embodiments, after mixing the two or more materials, process 700 may further include cleaning one or more mixer assemblies and/or one or more other components. For example, the controller may be configured to monitor one or more mixer assemblies 200 and/or one or more other components. If the controller determines that one or more components require cleaning over a predefined threshold level, the controller may be configured to utilize a self-mixing device to automatically clean the one or more mixer assemblies 200 and/or the one or more other components

In various embodiments, use of continuous paste mixer 100 described herein may result in various advantages. For example, continuous paste mixer 100 may improve productivity. For example, the continuous paste mixer 100 may be designed for high-volume production, making it more efficient for large-scale operations. The continuous paste mixer 100 may handle a steady flow of materials, leading to higher throughput and reduced downtime such as up to 80 Kg/175 lbs. of paste per minute or 800 grids. In some embodiments, continuous paste mixer 100 may also enable more optimal material usage, resulting in lower overall costs related to raw material consumption. In other embodiments, continuous paste mixer 100 may result in less scrap. For example, continuous mixing processes may generate less waste compared to batch mixing. This is because materials are continuously fed and mixed, reducing the chances of leftover or unused paste. In certain embodiments, continuous paste mixer 100 may also require reduced labor. For example, automation in continuous mixing reduces the need for manual intervention, leading to lower labor costs.

In some embodiments, continuous paste mixer 100 may have improve energy efficiency. Foe example, sustainable energy management reduces power consumption up to 90% vs. batch mixers due to their continuous operation, reduced downtime, optimized process control, and less frequent need for energy-intensive activities like start-up, shut-down, and cleaning. In various embodiments, continuous paste mixer 100 may lead to improved consistency and uniformity. Continuous mixers may provide a more consistent and uniform paste quality. This is because the mixing process is ongoing, reducing the variability that can occur between batches. In various embodiments, continuous paste mixer 100 may provide improved quality control. For example, continuous mixers may allow for real-time monitoring and adjustments, ensuring that the paste quality remains consistent throughout the production process. This leads to better quality control and fewer defects. In some embodiments, continuous paste mixer 100 may provide enhanced reaction control. For example, the paste mixture may involve exothermic reactions that can affect the paste's consistency if not properly managed. The continuous paste mixer described herein may have numerous temperature monitoring zones to optimize paste mixing management and highly controlled reaction temperature via multiple intercooler cooling modules.

In some embodiments, continuous paste mixer 100 may have also enable precise temperature, time, acid and water control to ensure optimal paste physical and chemical characteristics. In some embodiments, continuous paste mixer 100 may provide enhanced programmability with the capability to process unique parameters for a range of paste formulations and battery designs. In some embodiments, continuous paste mixer 100 may have no lead-in-air particulate during the mixing process due to its encapsulated reactor design. In some embodiments, continuous paste mixer 100 may also provide easy maintenance and cleaning due to automatic rinse feature and hydraulic assisted reactor opening and closing.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A multi-stage paste mixer for producing lead acid battery paste, the mixer comprising:
a plurality of inlets for receiving dry ingredients, acid, and water;
a mixing apparatus comprising at least two mixer assemblies extending horizontally, each mixer assembly including an elongated paddle shaft assembly; and
a drive assembly configured to independently rotate the elongated paddle shaft assemblies of the at least two mixer assemblies.

2. The multi-stage paste mixer of claim 1, wherein the at least two mixer assemblies comprise a first mixer assembly and a second mixer assembly, wherein the second mixer assembly is configured to receive as input an output from the first mixer assembly.

3. The multi-stage paste mixer of claim 2, wherein the first mixer assembly and the second mixer assembly are stacked vertically.

4. The multi-stage paste mixer of claim 1, the system further comprising a controller configured to independently control the at least two mixer assemblies according to one or more mixing profiles.

5. The multi-stage paste mixer of claim 1, the system further comprising a controller configured to independently control the plurality of inlets according to one or more mixing profiles.

6. The multi-stage paste mixer of claim 1, the system further comprising a controller configured to independently control the at least two mixer assemblies and the plurality of inlets according to one or more mixing profiles.

7. The multi-stage paste mixer of claim 1, wherein the drive assembly includes an electric motor and a gearbox, the drive assembly configured to provide rotational energy to the elongated paddle shaft assemblies.

8. A method for mixing ingredients without risking uncontrolled exothermic reactions during paste preparation, the method comprising:
installing a continuous paste mixer comprising a mixing apparatus secured to a frame, the mixing apparatus including one or more mixer assemblies configured to extend and stack with respect to the frame, the one or more mixer assemblies to mix ingredients (thixotropic and/or non-Newtonian) continuously and uniformly without risking uncontrolled exothermic reactions;
determining a mixing profile for mixing the ingredients in the one or more mixer assemblies;
generating uniformly mixed paste though the one or more mixer assemblies; and
automatically controlling movement and operation of the mixing apparatus according to the mixing profile to mix the ingredients in the one or more mixer assemblies.

9. The method of claim 8, further including:
monitoring two or more materials on a target parameter of a multi-parameter control system to measure an amount of the two or more material.

10. The method of claim 8, further including:
adjusting one or more pre-programmed patterns or mixing modes based on the measured amount of the two or more material.

11. The method of claim 8, further including:
adjusting and replacing one or more paddles of at least one of the one or more mixing assemblies.

12. The method of claim 8, further including:
cleaning at least one of the one or more mixing assemblies.
